(19) United States
(12) Patent Application Publication
(10) Pub. No.: US 2022/0276377 A1
(43) Pub. Date: Sep. 1, 2022

(54) ANTIREFLECTION MATERIAL AND USE THEREOF

(71) Applicant: NITTO DENKO CORPORATION, Ibaraki-shi, Osaka (JP)

(72) Inventor: Shu Sasaki, Ibaraki-shi, Osaka (JP)

(73) Assignee: NITTO DENKO CORPORATION, Ibaraki-shi, Osaka (JP)

(21) Appl. No.: 17/624,668

(22) PCT Filed: Jul. 2, 2020
(86) PCT No.: PCT/JP2020/026081

§ 371 Date: Jan. 4, 2022

(30) Foreign Application Priority Data
Jul. 5, 2019 (JP) 2019-126506

(51) Int. Cl. G01S 13/931; H01Q 15/00; G01S 7/35

(52) U.S. Cl. CPC G01S 13/931; H01Q 15/0026; G01S 7/352; G01S 2013/93275

(57) ABSTRACT

Provided is a technique for improving the radio wave transmission of a dielectric member, which reflects radio waves, without requiring a design change of the dielectric member itself. Provided is an antireflection material that is used by being laminated on a dielectric member, which reflects radio waves, to reduce the reflection of the radio waves. The dielectric member includes a base layer and a coating layer laminated on the base layer. The base layer has a thickness T_{YB} of 1.2 mm or more and 3.5 mm or less. The coating layer has a relative permittivity ε_{YC} of 3.0 or higher. The antireflection material has a thickness T_{X} of 10 mm or less. The antireflection material has a relative permittivity ε_{X} of 2.0 or more and 7.0 or less.

### TECHNICAL FIELD

The present invention relates to an antireflection material that prevents reflection of radio waves, a bumper with antireflection material in which the antireflection material being laminated on a vehicle bumper, and an in-vehicle radar system including the antireflection material.

This application claims priority based on Japanese Patent Application No. 2019-126506 filed on Jul. 5, 2019, and the entire contents of the application are incorporated herein by reference.

### BACKGROUND ART

A radar device detects the distance and direction to an obstacle present in the vicinity thereof by transmitting radio waves and receiving the reflected waves of the transmitted radio waves. A radar device mounted on a vehicle is often arranged inside a vehicle exterior part from the viewpoint of the durability of the device and the design of the vehicle. In this case, the vehicle exterior part is required to have high transparency to radio waves transmitted and received by the radar device in order to avoid deterioration of radar detection performance. Patent Literature 1 and 2 are examples of related art documents relating to the improvement of radio wave transmission.

### CITATION LIST

### Patent Literature

### Patent Literature 1: Japanese Patent Application Publication No. 2019-7776

### Patent Literature 2: Japanese Patent Application Publication No. 2007-248167

### SUMMARY OF INVENTION

### Technical Problem

Patent Literature 1 proposes an electromagnetic wave transmitting cover to improve the radio wave transmission performance by designing the cover to have a thickness of an integral multiple of ½ of the wavelength of electromagnetic wave. Further, Patent Literature 2 proposes a radio wave transmitting component to reduce the amount of radio wave transmission attenuation by setting the angle of the radio wave transmitting component. However, the techniques described in Patent Literature 1 and 2 are difficult to adopt or are ineffective in dielectric members having the same outer shape but different radio wave transmission depending on the type of coating, as represented by a bumper of a vehicle.

Therefore, an object of the present invention is to provide a technique for improving the radio wave transmission of a dielectric member that reflects radio waves without requiring a design change of the dielectric member itself.

### Solution to Problem

The present description provides an antireflection material used by being laminated on a dielectric member, which reflects radio waves, to reduce the reflection of the radio waves. The dielectric member includes a base layer and a coating layer laminated on the base layer. The base layer has a thickness T_{YB} of 1.2 mm or more and 3.5 mm or less. The coating layer has a relative permittivity ε_{YC} of 3.0 or higher. The antireflection material has a thickness T_{X} of 10 mm or less. The antireflection material has a relative permittivity ε_{X} of 2.0 or more and 7.0 or less. By additionally laminating the antireflection material on the dielectric member having such a configuration, the shape of a graph showing the frequency dependence of a transmission attenuation amount is adjusted, and favorable radio wave transmission performance can be realized in the dielectric member on which the antireflection material is laminated (dielectric member with the antireflection material). Here, the graph showing the frequency dependence of a transmission attenuation amount (hereinafter, also simply referred to as “frequency dependence graph”) is a graph in which the frequency (Hz) is plotted on the abscissa and the transmission attenuation amount (dB) is plotted on the ordinate and in which the numerical value increases toward the top of the ordinate. The numerical value of the transmission attenuation amount (dB) is usually zero or less, and it can be said that the larger the numerical value, the smaller the transmission attenuation amount and the better the radio wave transmission.

The antireflection material disclosed herein has a relative permittivity ε_{X} of 2.0 or more, thereby making it possible to significantly reduce the transmission attenuation amount in a predetermined frequency band (that is, increase the numerical value of the transmission attenuation amount). Further, when the antireflection material has a relative permittivity ε_{X} of 7.0 or less (for example, 4.5 or less), the peak shape of the frequency dependence graph can be smoothed and the transmission attenuation amount can be reduced in a wide band. This is significant, for example, in an embodiment in which the dielectric member is arranged in the radio wave transmission/reception path of a millimeter wave radar. By laminating the antireflection material on such a dielectric member, high radio wave transmission can be ensured in a wide wavelength band, and the distance resolution of the millimeter wave radar can be effectively improved. Further, when the antireflection material has a thickness T_{X} of 10 mm or less (for example, 0.05 mm or more and 2.00 mm or less), the antireflection material can be additionally laminated on the dielectric member while avoiding inconveniences such as cushioning with other members.

In some embodiments, the antireflection material includes a pressure-sensitive adhesive (PSA) layer Xa constituting a first surface of the antireflection material and is configured to be capable of being fixed to the dielectric member by the PSA layer Xa. An antireflection material (hereinafter, also referred to as “adhesive antireflection material”) having the first surface (adhesive surface) configured of the PSA layer Xa as described above is preferable, for example, because the adhesive antireflection material can be directly laminated and fixed to the dielectric member without the need for using an adhesive or heating and fusing. The feasibility of directly laminating the antireflection material on the dielectric member without using an adhesive improves workability and is also meaningful from the viewpoint of avoiding the adverse effect on the radio wave transmission performance due to the variation in the type and thickness of the adhesive. That is, the antireflection material having an adhesive surface to be attached to a dielectric member makes it possible to more accurately control the radio wave transmission performance of the dielectric member on which the antireflection material is laminated.

In some embodiments, the antireflection material includes a resin film Xn, which is a layer constituting a second surface of the antireflection material. The antireflection material having such a configuration has an advantage of favorable handleability and workability before lamination on a dielectric member.

This description also provides a dielectric member with antireflection material including any of the antireflection materials disclosed herein and the dielectric member on which the antireflection material is laminated. A preferred example of the dielectric member is a vehicle bumper (hereinafter, also simply referred to as a “bumper”).

In some embodiments, the dielectric member with antireflection material (for example, a bumper) preferably has a configuration in which a coating layer is arranged on an outer surface of the base layer, and the antireflection material is laminated on an inner surface of the base layer. In the dielectric member with antireflection material having such a configuration, the base layer can be designed by using the coating layer to form a dielectric member having a desired appearance, and favorable radio wave transmission performance can be obtained by using the antireflection material without impairing the appearance.

Further, this description also provides an in-vehicle radar system including any of the antireflection materials disclosed herein. The in-vehicle radar system includes the antireflection material, the dielectric member, and a radar device that transmits and receives radio waves. The antireflection material is laminated on the dielectric member. The antireflection material and the dielectric member are arranged in the radio wave transmission/reception path. The in-vehicle radar system having such a configuration can exhibit improved distance resolution as a result of being provided with the antireflection material.

An appropriate combination of the above-mentioned elements may be included in the scope of the invention for which protection by the patent is sought by this patent application.

### BRIEF DESCRIPTION OF DRAWINGS

FIG. 1 is a cross-sectional view schematically showing a bumper with an antireflection material according to an embodiment.

FIG. 2 is a cross-sectional view schematically showing the configuration of an antireflection material according to an embodiment.

FIG. 3 is a cross-sectional view schematically showing the configuration of an antireflection material according to another embodiment.

FIG. 4 is an explanatory diagram schematically showing an in-vehicle radar system including an antireflection material according to an embodiment.

### DESCRIPTION OF EMBODIMENTS

Hereinafter, preferred embodiments of the present invention will be described. Matters other than those specifically mentioned in the present description and necessary for the implementation of the present invention can be understood by a person skilled in the art on the basis of the teachings related to the implementation of the invention disclosed in the present description and the common technical knowledge at the time of filing. The present invention can be carried out based on the contents disclosed in the present description and common technical knowledge in the art. Further, in the following drawings, members/parts having the same action may be denoted with the same reference numerals, and duplicate description may be omitted or simplified. Further, the embodiments illustrated by the drawings are modeled for clearly explaining the present invention, and do not necessarily accurately represent the size and scale of the actually provided product.

### Example of Antireflection Material Usage

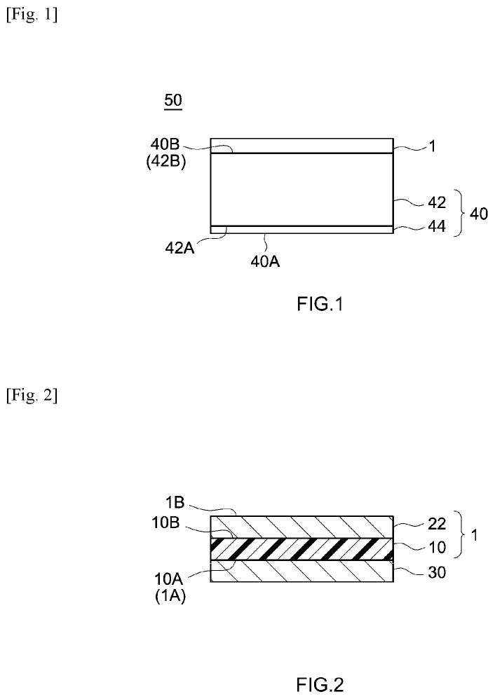

The antireflection material disclosed herein is used to reduce the reflection of radio waves and improve the radio wave transmission by lamination on a dielectric member that reflects the radio waves. FIG. 1 shows an example of the antireflection material usage. The antireflection material 1 shown in FIG. 1 is laminated on a bumper 40 as a dielectric member to form a bumper 50 with antireflection material. The bumper 40 includes a resin molded body 42 as a base layer and a paint layer 44 as a coating layer provided on the first surface (outer surface) 42A of the base layer. The second surface (inner surface) 42B of the resin molded body 42 also serves as an inner surface 40B of the bumper 40, and the antireflection material 1 is fixed thereto.

FIG. 2 shows the configuration of the antireflection material according to one embodiment. The antireflection material 1 shown in FIG. 2 has a structure in which a PSA layer 10 and a resin film 22 as a support layer are laminated. A first surface 1A of the antireflection material 1 is an adhesive surface formed with a PSA layer (surface layer) 10. As a result, the antireflection material (adhesive antireflection material) 1 can be attached to an adherend (in the example shown in FIG. 1, the inner surface 40B of the bumper 40) by pressing the surface (adhesive surface) 10A of the PSA layer 10 to the adherend. The second surface (back surface) 1B of the antireflection material 1 is formed with a resin film (back layer) 22 laminated on the second surface 10B of the PSA layer 10. The antireflection material 1 before use (that is, before being attached to the adherend) may be in a form in which the adhesive surface 10A is protected by a release liner 30 having at least one surface as a release surface (peeling surface). Alternatively, the back surface 1B of the antireflection material 1 may be a peeling surface, and the adhesive surface 10A may be protected by winding or laminating so that the adhesive surface 10A is in contact with the back surface 1B.

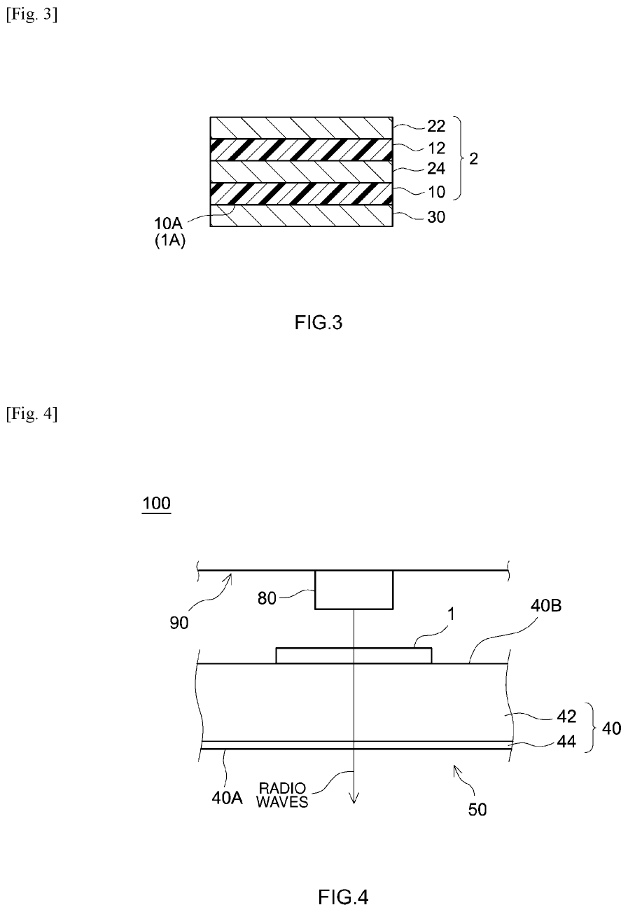

FIG. 3 shows the configuration of the antireflection material according to another embodiment. An antireflection material 2 shown in FIG. 3 has a configuration in which a PSA layer (intermediate layer) 12 and a resin film (intermediate layer) 24 are arranged between the PSA layer 10 and the resin film 22 of the antireflection material 1 shown in FIG. 2. The thickness of the PSA layer 10 and the PSA layer 12 can be independently selected. In other words, the PSA layer 10 and the PSA layer 12 may have the same thickness or different thicknesses. Similarly, the materials (and the relative permittivity) of the PSA layer 10 and the PSA layer 12 can be independently selected. The same applies to the thickness and material of the resin films 22 and 24.

In the configuration shown in FIG. 1, the antireflection material 1 is laminated on the inner surface 40B of the dielectric member 40, but this arrangement of the antireflection material 1 is not limiting, and the antireflection material 1 may be arranged on the outer surface 40A of the dielectric member 40 or on both the outer surface 40A and the inner surface 40B. Further, as shown in FIG. 1, the coating layer 44 may be arranged on the outer surface 42A of the base layer 42, the inner surface 42B, or both of them.

Hereinafter, each element that can be used in the technique disclosed herein (including an antireflection material, a dielectric member with antireflection material such as a bumper with antireflection material, an in-vehicle radar system, etc.; the same applies hereinbelow) will be described in more detail.

<Antireflection Material>

### (Relative Permittivity ε_{X} of Antireflection Material)

The relative permittivity ε_{X} of the antireflection material disclosed herein is preferably selected from the range of 2.0 or more and 7.0 or less. When the relative permittivity ε_{X} is 2.0 or more, the transmission attenuation amount can be significantly reduced. Further, when the relative permittivity ε_{X} is 7.0 or less (for example, 4.5 or less), the peak shape of the frequency dependence graph can be smoothed and the transmission attenuation amount can be reduced in a wide band. When the relative permittivity ε_{X} is 2.0 or more and 7.0 or less, radio wave transmission can be suitably improved in a wide frequency band. As a result, for example, the distance resolution of the millimeter wave radar can be effectively increased.

In some embodiments of the technique disclosed herein, the relative permittivity ε_{X} of the antireflection material may be, for example, 2.5 or more, 3.0 or more, or 3.5 or more. The relative permittivity ε_{X} of the antireflection material may be, for example, 6.5 or less, 6.0 or less, 5.5 or less, 5.0 or less, or 4.5 or less. In the antireflection material according to a preferred embodiment, the relative permittivity ε_{X} can be, for example, 2.0 or more and 5.0 or less. The antireflection material of such an embodiment can be preferably adopted in both the 76.5 GHz band and the 79 GHz band. In an antireflection material in which radio wave transmission in the 76.5 GHz band is more important, the relative permittivity ε_{X} can be, for example, 2.5 or more and 5.0 or less. In an antireflection material in which the radio wave transmission in the 79 GHz band is more important, the relative permittivity ε_{X} can be, for example, 2.0 or more and 4.5 or less.

Here, the “relative permittivity” in the present description means the relative permittivity in the millimeter wave band, and specifically, for example, the relative permittivity in the frequency range of 74.5 GHz to 81 GHz, unless otherwise specified. Depending on the intended use, for example, when the intention is to improve the transmission of radio waves of 76.5 GHz, the relative permittivity at a frequency of 76.5 GHz or in the vicinity thereof (preferably a frequency selected from the range of 76.5 GHz±0.5 GHz) can be used, and when the intention is to improve the transmission of radio waves at 79 GHz, the relative permittivity at a frequency of 79 GHz or in the vicinity thereof (preferably a frequency selected from the range of 79 GHz±2.0 GHz) can be used. When the intended frequency is not specified (for example, in the case of an antireflection material that can be used in both the 77 GHz band and the 79 GHz band), the value of permittivity at 77 GHz can be used as a typical value of the relative permittivity in the range of 74.5 GHz to 81 GHz.

The relative permittivity is measured under conditions of 25° C. and 50% by using a commercially available measuring device based on a known method such as an open resonator method (JIS R 1660-2), a free space frequency change method, an S-parameter method and the like. As the commercially available measuring device, for example, a permittivity/dielectric loss tangent measurement system Model No. DPS10 manufactured by KEYCOM CORP. can be used. Other measuring devices that can obtain the equivalent results may be used as well.

When the antireflection material disclosed herein has a laminated structure including two or more layers (Layer A . . . Layer N), a value measured by the abovementioned method or a value of the total relative permittivity ε_{SUM} calculated by the following formula (A) from the relative permittivity and thickness of each layer may be used as the relative permittivity ε_{X} of the antireflection material. Here, Tₐ . . . Tₙ is the thickness (mm) of each layer, and εₐ . . . εₙ is the relative permittivity of each layer. As the relative permittivity of each layer, a value measured by the abovementioned method for the layer or a material having the same composition as the layer can be used. In addition, where there is a nominal value provided by the manufacturer or the like or a value described in other publicly known materials as the relative permittivity of the layer or a material having the same composition as the layer, that value may be adopted. This formula is applicable only to the real part of the complex relative permittivity.

$$\begin{matrix}[ Math . 1 ] & \\ {ε}_{SUM} = \frac{( {T}_{a} \times {ε}_{a} + {T}_{b} \times {ε}_{b} + … + {T}_{n} \times {ε}_{n} )}{( {T}_{a} + {T}_{b} + … + {T}_{n} )} & ( A )\end{matrix}$$

(Thickness T_{X} of Antireflection Material)

The thickness T_{X} of the antireflection material can be set so as to achieve, as appropriate, the purpose of use of the antireflection material, and is not particularly limited. From the viewpoint of avoiding inconveniences such as buffering with other members caused by laminating the antireflection material on the dielectric member, it may be advantageous to set the thickness T_{X} of the antireflection material to about 10 mm or less. From this viewpoint, in some embodiments, the thickness T_{X} of the antireflection material may be, for example, 8.0 mm or less, 5.0 mm or less, 2.0 mm or less, 1.5 mm or less, 1.0 mm or less, or less than 1.0 mm. The lower limit of the thickness T_{X} of the antireflection material is not particularly limited, but in consideration of handleability and the effect of use of the antireflection material, it is usually appropriate to set the thickness to 0.02 mm or more, and it is preferable to set the thickness to 0.05 mm or more. In some embodiments, the antireflection material thickness T_{X} may be, for example, 0.1 mm or more, 0.3 mm or more, or 0.5 mm or more.

In some embodiments of the technique disclosed herein, the thickness T_{X} of the antireflection material can be set such as to configure a dielectric member with antireflection material in which the peak of the frequency dependence graph is 74.5 GHz to 81 GHz (preferably 75.5 GHz to 81 GHz, more preferably 76 GHz to 81 GHz) in relation to the dielectric member on which the antireflection material is laminated. By setting the thickness T_{X} of the antireflection material in consideration of the peak frequency of the frequency dependence graph in this way, a dielectric member with antireflection material that exhibits high radio wave transmission in a wide wavelength band near the frequency of interest can be advantageously realized. In an antireflection material in which radio wave transmission in the 76.5 GHz band is more important, the thickness T_{X} is preferably set so that the peak of the frequency dependence graph is within the range of 76.5 GHz±1 GHz (more preferably 76.5 GHz±0.5 GHz, and still more preferably 76.5 GHz±0.2 GHz). In an antireflection material in which radio wave transmission in the 79 GHz band is more important, the thickness T_{X} is preferably set so that the peak of the frequency dependence graph is within the range of 79 GHz±1 GHz (more preferably 79GHz ±0.5 GHz, and still more preferably 79 GHz±0.2 GHz).

(Surface Layer Xa)

The antireflection material disclosed herein includes the surface layer Xa constituting the first surface of the antireflection material. The antireflection material may have a single-layer structure composed of the surface layer Xa, or may have a structure further including a layer other than the surface layer Xa. The thickness and material of the surface layer Xa can be selected, as appropriate, in consideration of, for example, the relative permittivity of the surface layer Xa, the relative permittivity ε_{X} of the entire antireflection material including the surface layer Xa, the purpose and mode of use of the antireflection material, and the like.

Although not particularly limited, the relative permittivity of the surface layer Xa may be, for example, 2.0 or more, 2.5 or more, 3.0 or more, or 3.5 or more. Further, the relative permittivity of the surface layer Xa may be, for example, 10.0 or less, 8.0 or less, 7.0 or less, 6.0 or less, 5.5 or less, 5.0 or less, or 4.5 or less.

In the antireflection material according to some preferred embodiments, the surface layer Xa is a PSA layer. The thickness and material of the PSA layer Xa can be selected, as appropriate, in consideration of, for example, the relative permittivity of the PSA layer Xa, the relative permittivity ε_{X} of the entire antireflection material including the PSA layer Xa, and the adhesive performance corresponding to the purpose and mode of use. A PSA constituting the PSA layer Xa can be selected from, for example, PSAs including one or two or more various polymers such as acrylic polymer, rubber-based polymer, polyester-based polymer, urethane-based polymer, polyether polymer, silicone-based polymer, polyamide-based polymer, and fluorine-based polymer as a base polymer. In an embodiment in which the antireflection material disclosed herein includes a PSA layer other than the PSA layer Xa (for example, the intermediate layer 12 shown in FIG. 3), the PSA layer can also be selected from the above-mentioned PSAs. In addition, in this description, the “base polymer” of a PSA means the main component (typically, the component contained in more than 50% by weight) of the polymer component contained in the PSA. As will be described in detail hereinbelow, suitable examples of the PSA layer that can be used for the antireflection material disclosed herein include an acrylic PSA layer (that is, a PSA layer containing an acrylic polymer as a base polymer) and a rubber-based PSA.

The thickness of the surface layer Xa can be selected from the range equal to or below the thickness of the antireflection material, and is not particularly limited. In the embodiment in which the surface layer Xa is a PSA layer, the thickness of the PSA layer Xa may be, for example, 0.01 mm or more, and from the viewpoint of adhesion to the dielectric member, the advantageous thickness is 0.02 mm or more. The thickness may be 0.03 mm or more, or 0.05 mm or more. In some embodiments, the thickness of the PSA layer Xa may be 0.07 mm or more, 0.10 mm or more, or 0.15 mm or more from the viewpoint of adjusting the relative permittivity ε_{X}, shock absorption, and the like. Further, from the viewpoint of improving the workability of the antireflection material and preventing the PSA from oozing out and the adhesion of dirt on the outer peripheral end surface of the antireflection material, the thickness of the PSA layer Xa is, for example, 1.00 mm or less and may be 0.80 mm or less, 0.50 mm or less, or 0.30 mm or less. In some embodiments, from the viewpoint of adjusting the relative permittivity ε_{X} and reducing the thickness, the thickness of the PSA layer Xa may be 0.20 mm or less, or 0.10 mm or less.

(Back Layer Xn)

In some embodiments of the antireflection material disclosed herein, the second surface of the antireflection material is formed with a back layer Xn. The antireflection material may have a two-layer structure including the surface layer Xa and the back layer Xn, and may have a structure further including a layer (intermediate layer) arranged between the surface layer Xa and the back layer Xn in addition to the layers Xa and Xn. The thickness and material of the back layer Xn can be selected, as appropriate, in consideration of, for example, the relative permittivity of the back layer Xn, the relative permittivity ε_{X} of the entire antireflection material including the back layer Xn, the purpose and mode of use of the antireflection material, and the like.

Although not particularly limited, the relative permittivity of the back layer Xn may be, for example, 2.0 or more, 2.5 or more, 3.0 or more, or 3.5 or more. The relative permittivity of the back layer Xn may be, for example, 20.0 or less, 10.0 or less, 8.0 or less, 7.0 or less, 6.0 or less, 5.5 or less, 5.0 or less, or 4.5 or less. The relative permittivity of the surface layer Xa and the relative permittivity of the back layer Xn may be about the same or different.

In some embodiments, the back layer Xn can be a non-adhesive support layer. As the support layer Xn, a resin film, paper, cloth, a rubber sheet, a foam film, or the like can be used. The resin film referred to herein is, for example, a film formed in a film shape by using a resin material mainly composed of a resin as shown below, and is a concept that is distinguished from so-called non-woven fabrics and woven fabrics (that is, a concept excluding non-woven fabrics and woven fabrics). For example, a substantially non-foamed resin film can be preferably used as the back layer Xn. Here, the non-foamed resin film refers to a resin film that has not been intentionally treated to form a foam, and specifically can be a resin film with a foaming ratio of less than about 1.1 times (for example, less than 1.05 times, and typically less than 1.01 times).

Non-limiting examples of resins that can be used to form the resin film include polyester resins (for example, polyethylene terephthalate (PET), polybutylene terephthalate, polyethylene naphthalate, and the like), polyolefin resins (for example, polyethylene (PE), polypropylene (PP), ethylene/propylene copolymer, and the like), ethylene-vinyl acetate copolymer, vinyl acetate resins, polyurethanes (ether-based polyurethanes, ester-based polyurethanes, carbonate-based polyurethanes, and the like), urethane (meth)acrylates, thermoplastic elastomers (for example, olefin-based elastomers, styrene-based elastomers, acrylic-based elastomers, and the like), polyamides (for example, nylon 6, nylon 66, partially aromatic polyamides, and the like), polyimides, polyamideimides, polyether ether ketones, polyether sulfones, polyphenylene sulfides, polycarbonates, acrylic resins, polyacrylates (ACM), polystyrene, cellophane, polyvinyl chloride, polyvinylidene chloride, and the like. The resin film may be formed by using a resin material including one kind of such a resin alone, or may be formed by using a resin material in which two or more kinds are blended. The resin film may be, for example, a non-stretched film, a uniaxially stretched film, or a biaxially stretched film. In some embodiments, a polyester resin film formed from a resin material mainly composed of a polyester resin as described above, a polyolefin resin film formed from a resin material mainly composed of a polyolefin resin, or the like can be preferably used. A polyester resin film is preferable from the viewpoint of dimensional stability and durability, and a PET film is particularly preferable.

The thickness of the back layer Xn is not particularly limited. The thickness of the back layer (for example, the resin film) Xn may be, for example, 0.002 mm or more, 0.005 mm or more, 0.01 mm or more, or 0.02 mm or more. In some embodiments, from the viewpoint of adjusting the relative permittivity ε_{X}, strength, and the like, the thickness of the back layer Xn may be 0.07 mm or more, 0.09 mm or more, 0.12 mm or more, and 0.15 mm or more. Further, in some embodiments, the thickness of the back layer Xn is, for example, 2.00 mm or less, and from the viewpoint of conformity to the surface shape of the dielectric member, preferably 1.00 mm or less and may be 0.80 mm or less, 0.60 mm or less, 0.50 mm or less, 0.30 mm or less, 0.20 mm or less, or 0.15 mm or less.

(Intermediate Layer)

The antireflection material may further have one or two or more intermediate layers between the surface layer Xa and the back layer Xn. As described above, the antireflection material having an intermediate layer can be advantageous from the viewpoint of easy adjustment of the relative permittivity ε_{X} and the thickness T_{X} of the antireflection material. The thickness and material of the intermediate layer (each intermediate layer in the embodiment including two or more intermediate layers; the same applies hereinbelow) can be selected, as appropriate, in consideration of the relative permittivity of the intermediate layer, the relative permittivity ε_{X} of the entire antireflection material including the intermediate layer, the purpose and mode of use of the antireflection material, and the like. The intermediate layer may be formed with for example, the materials exemplified above as the constituent materials of the surface layer Xa or the back layer Xn. The thickness of the intermediate layer is not particularly limited. The thickness of the intermediate layer can be selected from, for example, the thickness exemplified above as the thickness of the surface layer Xa or the back layer Xn. The number of intermediate layers (number of layers) may be, for example, 1 to 20, may be 1 to 10, or may be 1 to 5.

### <Dielectric Member>

The antireflection material disclosed herein is used by being laminated on a dielectric member. The dielectric member includes a base layer and a coating layer laminated on the base layer. By laminating any of the antireflection materials disclosed herein on the dielectric member, the dielectric member with the antireflection material is formed. Although not particularly limited, in the dielectric member, the base layer is for ensuring shape retention and durability of the dielectric member (for example, a bumper), and the coating layer (in the case where two or more layers are included, at least one or more layers therefrom) may be a layer used for designing the base layer.

(Base Layer)

The material of the base layer is not particularly limited as long as at least a part of radio waves (for example, radio waves in the millimeter wave band, preferably radio waves of 74.5 GHz to 81 GHz) can be transmitted. The material of the base layer can be selected from, for example, resins, paper, cloth, glass, ceramics, a mixture or composite thereof, a foam, and the like. The base layer can be formed from any of the resin materials exemplified as the materials that can be used for forming the resin film. The antireflection material disclosed herein can be preferably applied to, for example, a dielectric member having a base layer formed of a polyolefin resin (for example, polypropylene resin) or a polyester resin.

The relative permittivity ε_{YB} of the base layer is not particularly limited. The relative permittivity ε_{YB} of the base layer may be, for example, 5.0 or less, preferably 4.0 or less, more preferably 3.0 or less, and may be 2.8 or less, 2.7 or less, and 2.6 or less. Further, the relative permittivity ε_{YB} of the base layer may be, for example, 1.0 or more, 2.0 or more, 2.1 or more, 2.2 or more, or 2.3 or more. The antireflection material disclosed herein can be preferably applied to, for example, a dielectric member having a base layer that has a relative permittivity ε_{YB} of 2.2 or more and 2.7 or less (for example, a polyolefin resin base layer having such relative permittivity ε_{YB}).

The thickness T_{YB} of the base layer may be, for example, 1.0 mm or more, preferably 1.2 mm or more, and may be 1.5 mm or more. The antireflection material disclosed herein can be applied to a dielectric member having a base layer thickness T_{YB} of 2.0 mm or more, and can advantageously exert an effect of improving radio wave transmission. Further, the thickness T_{YB} of the base layer may be, for example, 4.0 mm or less, preferably 3.5 mm or less. The preferred application target of the antireflection material disclosed herein can be exemplified by a dielectric member having a base layer thickness T_{YB} of 1.2 mm or more and 2.3 mm or less, and a dielectric member having a base layer thickness T_{YB} of 2.4 mm or more and 3.5 mm or less. In a dielectric member having such a thickness T_{Y}, the effect of laminating the antireflection material can be more advantageously exhibited.

(Coating Layer)

The coating layer in the dielectric member may have a single-layer structure or a structure including two or more layers. The coating layer may be, for example, a paint layer formed by applying a paint to the base layer. The paint referred to herein is a concept inclusive of a so-called undercoat paint (sometimes called primer), intermediate paint, and finish paint (sometimes called a top coat, clear coat, and the like) and the like. The form of the paint used for the paint layer is not particularly limited, and may be a water-based paint, a solvent-based paint, a powder paint, or the like. The material of the paint is not particularly limited, and for example, epoxy-based paint, urethane-based paint, acrylic-based paint, polyester-based paint, alkyd-based paint (for example, aminoalkyd resin paint), melamine-based paint, nitrocellulose-based paint, or composite systems thereof (for example, alkyd melamine-based paint, acrylic melamine-based paint, acrylic urethane-based paint, polyester melamine-based paint), and the like. Non-limiting examples of the above-mentioned paints include metallic paints such as silver-based paints. The paint (for example, intermediate coating paint) constituting the coating layer may include a colorant such as a pigment or a dye. In some embodiments, the coating layer includes at least one layer containing a colorant.

The relative permittivity ε_{YC} of the coating layer may be, for example, 2.0 or more, or 2.5 or more. In some embodiments, the relative permittivity ε_{YC} of the coating layer is preferably 3.0 or higher. In such an embodiment, the effect of adopting the antireflection material disclosed herein can be suitably exhibited. The relative permittivity ε_{YC} of the coating layer may be 3.5 or more, or 4.0 or more. The relative permittivity ε_{YC} of the coating layer may be, for example, 15.0 or less, 10.0 or less, or 8.0 or less.

In the coating layer including two or more layers, the relative permittivity ε_{YC} of the coating layer may be a value measured by the abovementioned method or a value of the total relative permittivity calculated by the following formula (A) as in the case of the relative permittivity ε_{X} of the antireflection material including two or more layers. In addition, where there is a nominal value provided by the manufacturer or the like or a value described in other publicly known materials, that value may be adopted as the relative permittivity of each layer or the relative permittivity ε_{YC} of the entire coating layer.

The thickness T_{YC} of the coating layer may be, for example, 0.01 mm or more, 0.02 mm or more, or 0.03 mm or more. The antireflection material disclosed herein can be advantageously used by being laminated on a dielectric member having the thickness T_{YC} of the coating layer of 0.05 mm or more (more preferably 0.07 mm or more, for example 0.08 mm or more). The thickness T_{YC} of the coating layer may be, for example, 0.5 mm or less, 0.3 mm or less, or 0.2 mm or less. The ratio of the thickness T_{YB} of the base layer to the thickness T_{YC} of the coating layer may be, for example, about 50 to 1000, about 80 to 500, or about 100 to 400.

The thickness T_{Y} of the dielectric member may be, for example, 1.0 mm or more, preferably 1.3 mm or more, and may be 1.6 mm or more, 1.8 mm or more, or 2.1 mm or more. The thickness T_{Y} of the dielectric member may be, for example, 4.2 mm or less, preferably 4.0 mm or less, and may be 3.8 mm or less, or 3.6 mm or less. Preferred application targets of the antireflection material disclosed herein are exemplified by a dielectric member having a thickness T_{Y} of 1.3 mm or more and 2.4 mm or less, and a dielectric member having a thickness T_{Y} of 2.5 mm or more and 3.6 mm or less. With a dielectric member having such a thickness TY, the effect of laminating the antireflection material can be more preferably exhibited.

<Dielectric Member with Antireflection Material>

This description provides a dielectric member with antireflection material that includes any of the antireflection materials disclosed herein and a dielectric member on which the antireflection material is laminated. A vehicle bumper is mentioned as a preferable example of the dielectric member. Therefore, a preferred example of the dielectric member with antireflection material disclosed herein is a bumper with antireflection material that includes any of the antireflection materials disclosed herein and a vehicle bumper on which the antireflection material is laminated. The vehicle bumper may be, for example, a front bumper or a rear bumper. In a vehicle equipped with a radar device (for example, a radar device using millimeter waves of 76.5 GHz or 79 GHz), it is preferable that the bumper be arranged in the radio wave transmission/reception path of the radar device. By laminating the antireflection material on such a bumper, the distance resolution of the radar device can be effectively improved. The assortment of vehicle bumpers of different colors and textures is often provided by using resin molded bodies of the same type and changing the type of paint (coating layer) applied to the molded body. In such a case, even if the dielectric members have substantially the same outer shape, the radio wave transmission characteristics of the dielectric members may differ depending on the type of the coating layer. The technique disclosed herein can improve the radio wave transmission by additionally laminating, as needed, an appropriate antireflection material on the dielectric member, without the necessity of changing the design of the dielectric member itself

<In-vehicle Radar System>

The antireflection material disclosed herein can be preferably used as a component of an in-vehicle radar system. The in-vehicle radar system may be configured using a dielectric member with antireflection material in which the antireflection material is laminated on the dielectric member. Therefore, this description provides an in-vehicle radar system including any of the antireflection materials disclosed herein, a dielectric member on which the antireflection material is laminated, and a radar device for transmitting and receiving radio waves. Here, the antireflection material and the dielectric member are arranged in the radio wave transmission/reception path. For example, as shown in FIG. 4, provided is an in-vehicle radar system 100 which includes the dielectric member 40 laminated with the antireflection material 1 and a radar device 80 attached to a vehicle body 90 to transmit and receive radio waves, in which the antireflection material 1 and the dielectric member 40 are arranged in the transmission/reception path of the radio waves. Such an in-vehicle radar system is preferable because the transmission of radio waves transmitted and received by the radar device can be improved. The dielectric member may be a vehicle bumper or may be another member arranged in a radio wave transmission/reception path. In some embodiments, the radio wave used in the radar device is preferably a radio wave in the 76.5 GHz band or 79 GHz band.

<PSA Layer>

Hereinafter, the PSA layer that can be used as the surface layer Xa and/or the intermediate layer in some embodiments of the antireflection material disclosed herein will be exemplified, but the PSA that can be used in the present invention is not limited to those described hereinbelow.

(Acrylic PSA)

In a preferred embodiment, the PSA constituting the PSA layer is an acrylic PSA including an acrylic polymer as a base polymer. Here, the acrylic polymer means a polymer derived from a monomer component including an acrylic monomer in an amount of more than 50% by weight. The acrylic monomer refers to a monomer having at least one (meth)acryloyl group in a molecule. In addition, in this description, “(meth)acryloyl” comprehensively means acryloyl and methacryloyl. Similarly, “(meth)acrylate” means acrylate and methacrylate, and “(meth)acrylic” comprehensively means acrylic and methacrylic, respectively.

Further, “mass” and “weight” are assumed to be synonymous in this description.

As the acrylic polymer, for example, a polymer of a monomer raw material including an alkyl (meth)acrylate as a main monomer and further including a secondary monomer copolymerizable with the main monomer is preferable. Here, the main monomer means a component that accounts for more than 50% by weight of all the monomer components in the monomer raw material.

As the alkyl (meth)acrylate, for example, a compound represented by the following formula (B) can be preferably used.

CH₂=C(R¹)COOR² (B)

Here, R¹ in the formula (B) is a hydrogen atom or a methyl group. Further, R² is a chain alkyl group having 1 to 20 carbon atoms (hereinafter, such a range of carbon atoms may be referred to as “C₁₋₂₀”). From the viewpoint of storage elastic modulus and the like of the PSA, an alkyl (meth)acrylate in which R² is a C₁₋₁₄ (for example, C₂₋₁₀, typically C₄₋₈) chain alkyl group is preferable, and an alkyl acrylate in which R¹ is a hydrogen atom and R² is a C₄₋₈ chain alkyl group is more preferable.

Examples of the alkyl (meth)acrylate in which R² is a C₁₋₂₀ chain alkyl group include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, pentyl (meth)acrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, lauryl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, isostearyl (meth)acrylate, nonadecyl (meth)acrylate, eicocyl (meth)acrylate, and the like. These alkyl (meth)acrylates may be used alone or in combination of two or more. Preferred alkyl (meth)acrylates include n-butyl acrylate (BA) and 2-ethylhexyl acrylate (2EHA).

The amount of the main monomer in all the monomer components is preferably about 70% by weight or more (for example, about 85% by weight or more, typically about 90% by weight or more). The upper limit of the amount of the main monomer is not particularly limited, but it is usually preferably about 99.5% by weight or less (for example, about 99% by weight or less). When a C4-8 alkyl acrylate is used as the monomer component, the amount of the C4-8 alkyl acrylate in the alkyl (meth)acrylate contained in the monomer component is preferably about 70% by weight or more, and more preferably 90% by weight or more, and further preferably about 95% by weight or more (typically about 99% by weight or more and about 100% by weight or less). The technique disclosed herein can be preferably carried out in an embodiment in which approximately 50% by weight or more (for example, approximately 60% by weight or more) of all monomer components is BA. The total monomer component may further include 2EHA in a smaller amount than BA. In one embodiment, the entire C₄₋₈ alkyl acrylate contained in the monomer component may be BA.

A secondary monomer copolymerizable with the alkyl (meth)acrylate, which is the main monomer, can be useful for introducing crosslinking points into the acrylic polymer and enhancing the cohesive force of the acrylic polymer. One or two or more functional group-containing monomers such as a carboxy group-containing monomer, a hydroxyl group-containing monomer, an acid anhydride group-containing monomer, an amide group-containing monomer, an amino group-containing monomer, a keto group-containing monomer, a monomer having a nitrogen atom-containing ring, an alkoxysilyl group-containing monomer, an imide group-containing monomer and an epoxy group-containing monomer can be used as the secondary monomer. For example, from the viewpoint of improving the cohesive force, an acrylic polymer in which a carboxy group-containing monomer and/or a hydroxyl group-containing monomer is copolymerized as the secondary monomer is preferable.

Preferable examples of the carboxy group-containing monomer include acrylic acid (AA) and methacrylic acid (MAA).

Examples of the hydroxyl group-containing monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, and 4-hydroxybutyl (meth)acrylate and unsaturated alcohols. Of these, hydroxyalkyl (meth)acrylates are preferable, and 2-hydroxyethyl acrylate (HEA) and 4-hydroxybutyl acrylate (4HBA) are more preferable.

Examples of the acid anhydride group-containing monomer include maleic anhydride, itaconic anhydride, acid anhydrides of the carboxy group-containing monomers, and the like.

Examples of the amide group-containing monomer include acrylamide, methacrylamide, diethylacrylamide, N-methylol (meth)acrylamide, N,N-dimethyl (meth)acrylamide, N,N-diethyl (meth)acrylamide, and N,N′-methylenebisacrylamide, N,N-dimethylaminopropyl acrylamide, N,N-dimethylaminopropyl methacrylamide, diacetone acrylamide, and the like.

Examples of the amino group-containing monomer include aminoethyl (meth)acrylate, N,N-dimethylaminoethyl (meth)acrylate, N,N-dimethylaminopropyl (meth)acrylate, and the like.

Examples of the keto group-containing monomer include diacetone (meth)acrylamide, diacetone (meth)acrylate, vinyl methyl ketone, vinyl acetoacetate, and the like.

Examples of the monomer having a nitrogen atom-containing ring include N-vinyl-2-pyrrolidone, N-acryloylmorpholine, and the like.

Examples of the alkoxysilyl group-containing monomer include 3-(meth)acryloxypropyltrimethoxysilane, 3-(meth)acryloxipropyltriethoxysilane, and the like.

Examples of the imide group-containing monomer include cyclohexylmaleimide, isopropylmaleimide, N-cyclohexylmaleimide, itaconimide, and the like.

Examples of the epoxy group-containing monomer include glycidyl (meth)acrylate, methyl glycidyl (meth)acrylate, allyl glycidyl ether, and the like.

The amount of the secondary monomer can be selected, as appropriate, so as to realize desired properties, and is not particularly limited. In some embodiments, the amount of the secondary monomer is preferably about 0.5% by weight or more, and preferably about 1% by weight or more in the total amount of monomer components of the acrylic polymer. The amount of the secondary monomer is appropriately about 30% by weight or less, and preferably about 10% by weight or less (for example, about 5% by weight or less) based on all the monomer components. When a carboxy group-containing monomer is copolymerized in the acrylic polymer, the amount of the carboxy group-containing monomer is preferably, for example, about 0.1% by weight or more (for example, about 0.2% by weight or more, and typically about 0.5% by weight or more) and about 10% by weight or less (for example, about 8% by weight or less, and typically about 5% by weight or less) based on all the monomer components used for the synthesis of the acrylic polymer. When the hydroxyl group-containing monomer is copolymerized in the acrylic polymer, the amount of the hydroxyl group-containing monomer is preferably about 0.001% by weight or more (for example, about 0.01% by weight, and typically about 0.02% by weight or more) and about 10% by weight or less (for example, about 2% by weight or less) based on all the monomer components used for the synthesis of the acrylic polymer.

In the acrylic polymer disclosed herein, monomers other than the abovementioned monomers (other monomers) may be copolymerized for the purpose of adjusting the glass transition temperature (Tg) of the acrylic polymer, adjusting the viscoelasticity of the PSA, adjusting the adhesive performance, and the like. Non-limiting examples of the other monomers include sulfonic acid group-containing monomers, for example, styrene sulfonic acid, allyl sulfonic acid, 2-(meth)acrylamide-2-methylpropane sulfonic acid, and the like; phosphoric acid group-containing monomers, for example, 2-hydroxyethylacryloyl phosphate and the like; cyano group-containing monomers, for example, acrylonitrile, methacrylonitrile, and the like; vinyl esters such as vinyl acetate (VAc), vinyl propionate, vinyl laurate, and the like; aromatic vinyl compounds, for example, styrene, substituted styrene (α-methylstyrene and the like), vinyl toluene, and the like; aromatic ring-containing (meth)acrylates, for example, aryl (meth)acrylates (for example, phenyl (meth)acrylate), aryloxyalkyl (meth)acrylates (for example, phenoxyethyl (meth)acrylate), arylalkyl (meth)acrylates (for example, benzyl (meth)acrylate), and the like; olefinic monomers, for example, ethylene, propylene, isoprene, butadiene, isobutylene, and the like; chlorine-containing monomers, for example, vinyl chloride, vinylidene chloride, and the like; vinyl ether-based monomers, for example, methylvinyl ether, ethyl vinyl ether, and the like; other macromonomers having a radical polymerizable vinyl group at the end of a monomer obtained by polymerizing a vinyl group; and the like.

The above other monomers can be used alone or in combination of two or more. Among them, vinyl esters (for example, VAc) can be mentioned as a preferable example. The amount of the other monomers is preferably about 30% by weight or less (for example, about 10% by weight or less), and for example, about 0.01% by weight or more (typically, can be about 0.1% by weight or more), based on all the monomer components used for the synthesis of the acrylic polymer. When a vinyl ester-based monomer such as vinyl acetate is copolymerized as the other monomer, the amount of the vinyl ester-based monomer is preferably about 30% by weight or less, and may be 10% by weight or less and 7% by weight or less, and preferably about 0.01% by weight or more, and may be 0.1% by weight or more, 1% by weight or more, and 3% by weight or more based on all the monomer components used for the synthesis of the acrylic polymer.

A method for obtaining the acrylic polymer is not particularly limited, and various polymerization methods known as methods for synthesizing acrylic polymers, such as a solution polymerization method, an emulsion polymerization method, a lump polymerization method, a suspension polymerization method, and the like can be adopted as appropriate. For example, a solution polymerization method can be preferably used. Alternatively, active energy ray irradiation polymerization such as photopolymerization performed by irradiating with light such as UV (typically performed in the presence of a photopolymerization initiator), radiation polymerization performed by irradiating with radiation such as γ-rays and γ-rays, and the like may be adopted.

(Rubber-based PSA)

In another preferred embodiment of the antireflection material disclosed herein, the PSA layer is composed of a rubber-based PSA. The rubber-based PSA may include one or two or more rubber-based polymers selected from natural rubbers and synthetic rubbers.

The Mooney viscosity of natural rubbers is not particularly limited. In one embodiment, a natural rubber having a Mooney viscosity of about 10 or more (typically 30 or more, preferably 50 or more, for example, 65 or more) under the measurement conditions of MS (1+4) 100° C. can be used. Further, a natural rubber having the Mooney viscosity of about 150 or less (preferably 120 or less, for example, 100 or less) can be used.

Specific examples of synthetic rubber include polyisoprene, polybutadiene, polyisobutylene, butyl rubber, styrene-butadiene rubber (SBR), styrene-based block copolymers, and the like. Other examples of synthetic rubber include ethylene propylene rubber, propylene butene rubber, ethylene propylene butene rubber, and the like. Yet another example of synthetic rubber is a graft-modified natural rubber in which a natural rubber is grafted with another monomer (for example, acrylic monomer, styrene, and the like).

Specific examples of the styrene-based block copolymer include styrene-butadiene block copolymers, styrene-isoprene block copolymers, hydrogenated products thereof, and the like. Here, the styrene-butadiene block copolymer means a copolymer having at least one styrene block and at least one butadiene block. The same applies to the styrene isoprene copolymer. The styrene block refers to a segment in which styrene is the main monomer (a copolymerization component exceeding 50% by weight; the same applies hereinafter). The segment consisting substantially only of styrene is a typical example of the styrene block referred to here. The same applies to the butadiene block and the isoprene block.

In a preferred embodiment of the technique disclosed herein, the base polymer includes a styrene-based block copolymer. For example, the base polymer includes a styrene-butadiene block copolymer and/or a styrene isoprene block copolymer. Of the styrene-based block copolymers contained in the PSA, it is preferable that the amount of the styrene-butadiene block copolymer be 70% by weight or more, or the amount of the styrene-isoprene block copolymer be 70% by weight or more, or total amount of the butadiene block copolymer and the styrene isoprene block copolymer be 70% by weight or more. In a preferred embodiment, substantially the entire styrene-based block copolymer (for example, 95% by weight or more and 100% by weight or less) is a styrene-butadiene block copolymer. In another preferred embodiment, substantially the entire styrene-based block copolymer (for example, 95% by weight or more and 100% by weight or less) is a styrene isoprene block copolymer.

The styrene-based block copolymer may be mainly composed of a polymer having a linear structure such as a diblock copolymer or a triblock copolymer, and may be mainly composed of a polymer having a radial structure. From the viewpoint of adhesive strength (peeling strength) to an adherend and impact resistance, a styrene-based block copolymer with a diblock ratio of, for example, 30% by weight or more (more preferably 40% by weight or more, further preferably 50% by weight or more, particularly preferably 60% by weight or more, typically 65% by weight or more) can be preferably used. A styrene-based block copolymer having a diblock ratio of 70% by weight or more (for example, 75% by weight or more) may be used. Further, from the viewpoint of cohesiveness and the like, a styrene-based block copolymer having a diblock ratio of 90% by weight or less (more preferably 85% by weight or less, for example, 80% by weight or less) can be preferably used. For example, a styrene-based block copolymer having a diblock ratio of 60% by weight or more and 85% by weight or less can be preferably adopted.

The amount of styrene in the styrene-based block copolymer can be, for example, 5% by weight or more and 40% by weight or less. From the viewpoint of adhesive properties, a styrene-based block copolymer having a styrene amount of 10% by weight or more (more preferably larger than 10% by weight, for example, 12% by weight or more) is usually preferable. Further, from the viewpoint of adhesive strength to the adherend and impact resistance, a styrene-based block copolymer having a styrene amount of 35% by weight or less (typically 30% by weight or less, more preferably 25% by weight or less, for example, less than 20% by weight) is preferred. For example, a styrene-based block copolymer having a styrene amount of 12% by weight or more and less than 20% by weight can be preferably adopted.

The rubber-based PSA disclosed herein may be a PSA including a natural rubber and a synthetic rubber as a base polymer. As the synthetic rubber used in combination with the natural rubber, for example, one or two or more of the above-mentioned various synthetic rubbers can be used. From the viewpoint of adhesive properties, a combination of a synthetic rubber (styrene-based block copolymer, SBR, and the like) having a composition in which a styrene component is copolymerized and a natural rubber is preferable. For example, a combination of a natural rubber and a styrene-butadiene block copolymer, a combination of a natural rubber and a styrene-isoprene block copolymer, and the like can be preferably adopted. The relationship between the amount of natural rubber and synthetic rubber used is not particularly limited. For example, a composition including 5 parts by weight or more (preferably 10 parts by weight or more, for example, 20 parts by weight or more) and 120 parts by weight or less (preferably 80 parts by weight or less, more preferably 60 parts by weight or less, for example, 40 parts by weight or less) of synthetic rubber with respect to 100 parts by weight of natural rubber can be used.

(Urethane-based PSA)

In another preferred embodiment of the antireflection material disclosed herein, the PSA layer is composed of a urethane-based PSA. Here, the urethane-based PSA (layer) refers to a PSA (layer) including a urethane-based polymer as a base polymer. The urethane-based PSA is typically made of a urethane-based resin including a urethane-based polymer obtained by reacting a polyol with a polyisocyanate compound as a base polymer. The urethane-based polymer is not particularly limited and can be selected, as appropriate, from urethane-based polymers (ether-based polyurethanes, ester-based polyurethanes, carbonate-based polyurethanes, and the like) that can function as a PSA. Examples of the polyol include polyether polyols, polyester polyols, polycarbonate polyols, polycaprolactone polyols, and the like. Examples of the polyisocyanate compound include diphenylmethane diisocyanate, tolylene diisocyanate, hexamethylene diisocyanate, and the like.

(Mw of Base Polymer)

The weight average molecular weight (Mw) of the base polymer (preferably an acrylic polymer) disclosed herein is not particularly limited, and may be, for example, in the range of 10×10⁴ or more and 500×10⁴ or less. From the viewpoint of balancing the cohesive force and the adhesive force at a high level, the Mw of the base polymer is preferably 20×10⁴ or more, more preferably 30×10⁴ or more, still more preferably 40×10⁴ or more, and preferably 150×10⁴ or less, more preferably 110×10⁴ or less, and even more preferably 90×10⁴ or less. In a preferred embodiment, a polymer having an Mw of 40×10⁴ or more and 60×10⁴ or less (preferably an acrylic polymer) can be used as the base polymer. In another preferred embodiment, a polymer having an Mw of more than 60×10⁴ and 90×10⁴ or less (preferably an acrylic polymer) can be used as the base polymer. Here, Mw refers to a standard polystyrene-equivalent value obtained by gel permeation chromatography (GPC). As the GPC apparatus, for example, a model “HLC-8320GPC” (column: TSKgelGMH-H (S), manufactured by TOSOH CORPORATION) may be used. The same applies to the examples described hereinbelow.

(Tg of Base Polymer)

The glass transition temperature (Tg) of the base polymer is not particularly limited and may be, for example, −80° C. or higher. From the viewpoint of impact resistance, the base polymer (preferably an acrylic polymer) of the PSA disclosed herein is designed, as appropriate, to have a Tg of about −15° C. or lower (typically about −25° C. or lower, for example, about −40° C. or lower). Further, from the viewpoint of cohesiveness and the like, the base polymer is designed, as appropriate, to have a Tg of about −70° C. or higher (preferably −60° C. or higher, for example, −55° C. or higher).

Here, the Tg of the base polymer is the value obtained from the Fox formula on the basis of the Tg of the homopolymer of each monomer constituting the polymer and the weight fraction of the monomers (copolymerization ratio based on the weight). As shown hereinbelow, the Fox formula is a relational expression between the Tg of the copolymer and the glass transition temperature Tgi of the homopolymer obtained by homopolymerizing each of the monomers constituting the copolymer.

1/Tg=Σ(Wi/Tgi)

In the above Fox formula, Tg is the glass transition temperature (unit: K) of the copolymer, Wi is the weight fraction of the monomer i in the copolymer (copolymerization ratio based on the weight), and Tgi is the glass transition temperature (unit: K) of a homopolymer of the monomer i. As the Tg of the homopolymer, a value described in a publicly known material is adopted.

In the technique disclosed here, the following values are specifically used as the Tg of homopolymers.

| | | |
|---|---|---|
| 2-Ethylhexyl acrylate | −70° | C. |
| Butyl acrylate | −55° | C. |
| Vinyl acetate | 32° | C. |
| Acrylic acid | 106° | C. |
| Methacrylic acid | 228° | C. |
| 2-Hydroxyethyl acrylate | −15° | C. |
| 4-Hydroxybutyl acrylate | −40° | C. |

For Tg of homopolymers other than those exemplified above, the numerical values described in “Polymer Handbook” (3rd edition, John Wiley & Sons, Inc., 1989) are used. The highest value is adopted for the monomers for which a plurality of types of values is described in this document. Where no value is described in the Polymer Handbook, a value obtained by the measuring method described in Japanese Patent Application Publication No. 2007-51271 is used.

(Tackifying Resin)

The PSA layer disclosed herein may have a composition including a tackifying resin. The tackifying resin is not particularly limited, and various tackifying resins, for example, rosin-based tackifying resins, terpene-based tackifying resins, hydrocarbon-based tackifying resins, epoxy-based tackifying resins, polyamide-based tackifying resins, elastomer-based tackifying resins, phenol-based tackifying resins, ketone-based tackifying resins, and the like can be used. As such a tackifying resins, one type can be used alone or two or more types can be used in combination.

Specific examples of the rosin-based tackifying resins include unmodified rosins (raw rosins) such as gum rosin, wood rosin, tall oil rosin, and the like; modified rosins obtained by modifying these unmodified rosins by hydrogenation, disproportionation, polymerization, and the like (hydrogenated rosins, disproportionated rosins, polymerized rosins, other chemically modified rosins, and the like); various other rosin derivatives; and the like. When an acrylic polymer is used as the base polymer, it is preferable to use a rosin-based tackifying resin. For example, one of the above rosin-based tackifying resins can be selected alone, or two or three or more tackifying resins of different types and characteristics (for example, softening points) can be used in combination.

Examples of the terpene-based tackifying resins are terpene resins such as a-pinene polymer, β-pinene polymer, dipentene polymer, and the like; modified terpene resin obtained by modification (phenolic modification, aromatic modification, hydrogenation modification, hydrocarbon modification, and the like) of these terpene resins; and the like. Examples of the modified terpene resin include terpene-modified phenolic resin, styrene-modified terpene resin, aromatic-modified terpene resin, hydrogenated terpene resin, and the like. When an acrylic polymer is used as the base polymer, it is preferable to use a terpene-based tackifying resin (for example, a terpene-modified phenol resin). For example, it is preferable to use one or two or more of the above terpene-based tackifying resins (for example, terpene-modified phenolic resin) having different types, characteristics (for example, softening points), and the like.

Examples of the hydrocarbon-based tackifying resins include various hydrocarbon-based resins such as aliphatic (C5 series) petroleum resins, aromatic (C9 series) petroleum resins, aliphatic/aromatic copolymerized (C5/C9 series) petroleum resins, hydrogenation products thereof (for example, aliphatic petroleum resins obtained by hydrogenating aromatic petroleum resins), modification products thereof (for example, maleic anhydride modified products), coumarone resins, coumarone-indene resins, and the like.

In the technique disclosed herein, a tackifying resin having a softening point (softening temperature) of about 70° C. or higher (typically about 80° C. or higher, preferably about 100° C. or higher, more preferably about 110° C. or higher) can be preferably used. With a PSA including a tackifying resin having a softening point equal to or higher than the above-mentioned lower limit value, an antireflection material having more excellent adhesive strength can be realized. The upper limit of the softening point of the upper tackifying resin is not particularly limited, and can be, for example, about 200° C. or lower (typically about 180° C. or lower). The softening point of the tackifying resin referred to herein is defined as a value measured by the softening point test method (ring ball method) specified in any of JIS K 5902 and JIS K 2207.

The amount of the tackifying resin used is not particularly limited, and can be appropriately set so as to obtain a desired effect of use. The amount of the tackifying resin used with respect to 100 parts by weight of the base polymer can be, for example, 0.5 parts by weight or more, usually suitably 2 parts by weight or more, preferably 5 parts by weight or more, and more preferably 10 parts by weight or more, and may be 15 parts by weight or more, and further 20 parts by weight or more. In one embodiment, the amount of the tackifying resin used with respect to 100 parts by weight of the base polymer may be 25 parts by weight or more, or 30 parts by weight or more. Meanwhile, the amount of the tackifying resin used with respect to 100 parts by weight of the base polymer can be, for example, 150 parts by weight or less, usually suitably 120 parts by weight or less, preferably 90 parts by weight or less, and more preferably 60 parts by weight or less (for example, 50 parts by weight or less). The antireflection material disclosed herein can also be implemented in an embodiment including a PSA layer substantially free of a tackifying resin.

### EXAMPLES

Hereinafter, some examples of the present invention will be described, but the present invention is not intended to be limited to those examples. In the following description, “part” and “%” are based on weight unless otherwise specified.

### Test Example 1

### Examples A1 to A7

In the dielectric member with antireflection material (laminated structure of a coating layer, a base layer, and an antireflection layer) shown in FIG. 1, the relative permittivity ε_{X} of the antireflection material was changed within the range of 2.00 to 7.00 as shown in Table 1 under the condition that the thickness T_{YB} of the base layer was fixed at 2.7 mm, the relative permittivity ε_{YB} of the base layer was fixed at 2.4, the thickness T_{YC} of the coating layer was fixed at 0.1 mm, and the relative permittivity ε_{YC} of the coating layer was fixed at 7.5, and the average transmission attenuation (dB) in the frequency band of 76.5±2 GHz of the dielectric member with antireflection material according to each example was determined by the following method.

The relative permittivity (here, ε_{YB}, ε_{YC}, ε_{X}) of each layer constituting the dielectric member with antireflection material was calculated assuming that it was constant within the above frequency range. Further, the thickness T_{X} of the antireflection material was set such that the frequency (the peak frequency in the graph in which the transmission attenuation amount is plotted on the ordinate, and the numerical value increases toward the top of the ordinate) at which the transmission attenuation amount is the smallest in the graph showing the frequency dependence of the transmission attenuation amount was set to 76.5 GHz.

[Calculation Method of Average Transmission Attenuation Amount]

For each layer constituting the dielectric member with antireflection material, a propagation constant γᵢ (i =1, 2, . . . n) of the radio wave having a frequency f (Hz) is expressed by the following equation (1).

$$\begin{matrix}[ Math . 2 ] & \\ {γ}_{n} = j \frac{2 π}{λ} \sqrt{{ε}_{r}} & ( 1 )\end{matrix}$$

Here, j is an imaginary number

[Math. 3]

√−1

λ is the wavelength (m) of the radio wave, and εᵣ is the relative permittivity ε′ᵣ or the complex relative permittivity ε*ᵣ described hereinbelow.

The transmittance t (%) and the transmission attenuation amount T (dB) of the dielectric member with antireflection material with respect to radio waves at a frequency f (Hz) are represented by the following equations (2) and (3).

$$\begin{matrix}[ Math . 4 ] & \\ t = \frac{2}{( A + \frac{B}{{Z}_{0}} + C \times {Z}_{0} + D )} & ( 2 )\end{matrix}$$

$$\begin{matrix}[ Math . 5 ] & \\ T = 20 \times {log}_{10} ( \vert \frac{1}{t} \vert ) & ( 3 )\end{matrix}$$

Here, Z₀ in the equation (2) is the impedance of air (≈377). A, B, C, and D in the equation (2) are calculated by the following matrix calculation formula (4) from εᵢ (relative permittivity ε′ᵣ or the complex relative permittivity ε′ᵣ described hereinbelow), the propagation constant γᵢ, and the thickness dᵢ (m) of each layer.

$$\begin{matrix}[ Math . 6 ] & \\ [ \begin{matrix}A & B \\ C & D\end{matrix} ] = [ \begin{matrix}cosh ( {γ}_{1} {d}_{1} ) & \frac{1}{\sqrt{{ε}_{1}}} sinh ( {γ}_{1} {d}_{1} ) \\ \sqrt{{ε}_{1}} sinh ( {γ}_{1} {d}_{1} ) & cosh ( {γ}_{1} {d}_{1} )\end{matrix} ] \times [ \begin{matrix}cosh ( {γ}_{2} {d}_{2} ) & \frac{1}{\sqrt{{ε}_{2}}} sinh ( {γ}_{2} {d}_{2} ) \\ \sqrt{{ε}_{2}} sinh ( {γ}_{2} {d}_{2} ) & cosh ( {γ}_{2} {d}_{2} )\end{matrix} ] … [ \begin{matrix}cosh ( {γ}_{n} {d}_{n} ) & \frac{1}{\sqrt{{ε}_{n}}} sinh ( {γ}_{n} {d}_{n} ) \\ \sqrt{{ε}_{n}} sinh ( {γ}_{n} {d}_{n} ) & cosh ( {γ}_{n} {d}_{n} )\end{matrix} ] & ( 4 )\end{matrix}$$

By the above method, the transmission attenuation amount T (dB) was calculated in 0.2 GHz increments in the range of frequency f (Hz) of 60 GHz to 90 GHz, and a graph showing the frequency dependence of the transmission attenuation amount was obtained. Within this range, the average value of the transmission attenuation amount T (dB) in the range of 74.5 GHz to 78.5 GHz was obtained, and this was used as the average transmission attenuation amount (dB) of the dielectric member with antireflection material according to each example. The results are shown in Table 1.

Further, in the graph showing the frequency dependence of the transmission attenuation amount, the minimum value of the transmission attenuation amount in the range of 74.5 GHz to 78.5 GHz (that is, the transmission attenuation amount at the frequency having the largest transmission attenuation in the above range) was defined as the minimum transmission attenuation (dB). Since all of the dielectric members with an antireflection material of Examples 1A to A7 had the largest transmission attenuation amount at 78.5 GHz within the above range, the transmission attenuation amount at 78.5 GHz was recorded as the minimum transmission attenuation amount (dB). The results are shown in Table 1.

### Example A8

In the dielectric member with antireflection material of Example A1, the relative permittivity ε_{X} of the antireflection material was changed to 2.60, and the thickness T_{X} of the antireflection material was changed to 10.45 mm. For the dielectric member with antireflection material having such a configuration, the average transmission attenuation amount (dB) and the minimum transmission attenuation amount (dB) (transmission attenuation amount (dB) at 78.5 GHz) were determined by the above method. The results are shown in Table 1.

### Example N1

For the dielectric member obtained by excluding the antireflection material from Example A1, the average transmission attenuation amount (dB) was determined by the above method. Further, since the transmission attenuation amount (dB) at 78.5 GHz was the lowest in the range of 74.5 GHz to 78.5 GHz, this was recorded as the minimum transmission attenuation amount (dB). The results are shown in Table 1.

TABLE 1

| | | Example | Example | Example | Example | Example | Example | Example | Example | Example |
|---|---|---|---|---|---|---|---|---|---|---|
| | | N1 | A1 | A2 | A3 | A4 | A5 | A6 | A7 | A8 |
| Antireflection | Thickness (mm) | — | 0.80 | 0.78 | 0.73 | 0.66 | 0.60 | 0.56 | 0.53 | 10.45 |
| material | Relative permittivity | — | 2.00 | 2.50 | 3.00 | 4.00 | 5.00 | 6.00 | 7.00 | 2.60 |

| | | | | | | | | | |
|---|---|---|---|---|---|---|---|---|---|
| Average transmission attenuation amount (dB) | −1.47 | −0.29 | −0.14 | −0.07 | −0.08 | −0.15 | −0.24 | −0.34 | −0.53 |
| Minimum transmission attenuation amount (dB) | −1.62 | −0.31 | −0.21 | −0.16 | −0.19 | −0.25 | −0.36 | −0.47 | −1.06 |

| | |
|---|---|
| Frequency band: | 76.5 ± 2 GHz |
| Dielectric member: | Base layer thickness 2.7 mm, Base layer relative permittivity 2.4 |
| | Coating layer thickness 0.1 mm, Coating layer relative permittivity 7.5 |

As shown in Table 1, the dielectric members with antireflection material of Examples A1 to A8 have a higher numerical value of average transmission attenuation amount and also a higher numerical value of minimum transmission attenuation amount than the dielectric member of Example N1 having no antireflection material. That is, the antireflection materials constituting Examples A1 to A8 were used by being laminated on the dielectric member of Example N1, whereby the effect of improving the radio wave transmission in the above frequency band was exhibited. The antireflection materials of Examples A1 to A7 have an average transmission attenuation amount of −0.50 dB or more, which means that these antireflection materials exhibit an average transmittance of 89.2% or more in the above frequency band. Further, the antireflection materials of Examples A1 to A7 have a minimum transmission attenuation amount of −1.00 dB or more, which means that these antireflection materials exhibit a transmittance of at least 79.5% in the entire frequency band mentioned hereinabove. Thus, with the antireflection materials of Examples A1 to A7, the transmission attenuation amount can be reduced in a wide frequency band of 76.5±2 GHz. As a result, the effect of effectively improving the distance resolution can be obtained.

In the dielectric member with antireflection material of Example A8 in which the thickness of the antireflection material exceeded 10 mm, when the thickness of the antireflection material was changed to 9.25 mm, the average transmission attenuation amount became −0.47 dB.

### Examples N2 to N7

The average transmission attenuation amount (dB) in the frequency band of 76.5±2 GHz was determined by the above method for the dielectric members of Examples N2 to N4 in which the relative permittivity ε_{YB} of the base layer was fixed at 2.4, the thickness T_{YC} of the coating layer was fixed at 0.1 mm, and the thickness of the base layer and the relative permittivity ε_{YC} of the coating layer were changed as shown in Tables 2 and 3. The results are shown in Tables 2 and 3.

### Examples B1 to B3 and Examples C1 to C5

The average transmission attenuation amount (dB) in the frequency band of 76.5±2 GHz was determined by the above method for dielectric members with antireflection material having the configurations shown in Tables 2 and 3. The results are shown in Tables 2 and 3.

TABLE 2

| | | Example | Example | Example | Example | Example | Example |
|---|---|---|---|---|---|---|---|
| | | N2 | N3 | N4 | B1 | B2 | B3 |
| Dielectric | Base layer thickness (mm) | 1.20 | 1.75 | 2.30 | 1.20 | 1.75 | 2.30 |
| member | Coating layer relative permittivity | 6.5 | 3.0 | 9.0 | 6.5 | 3.0 | 9.0 |
| Antireflection | Thickness (mm) | — | — | — | 0.94 | 0.59 | 1.00 |
| material | Relative permittivity | — | — | — | 2.88 | 2.75 | 2.90 |

| | | | | | | |
|---|---|---|---|---|---|---|
| Average transmission attenuation amount (dB) | −0.53 | −0.84 | −0.53 | −0.06 | −0.03 | −0.33 |

| | |
|---|---|
| Frequency band: | 76.5 ± 2 GHz |
| Dielectric member: | Base layer relative permittivity 2.4 |
| | Coating layer thickness 0.1 mm |

TABLE 3

| | | Example | Example | Example | Example | Example | Example | Example | Example |
|---|---|---|---|---|---|---|---|---|---|
| | | N5 | N6 | N7 | C1 | C2 | C3 | C4 | C5 |
| Dielectric | Base layer thickness (mm) | 2.40 | 3.00 | 3.50 | 2.40 | 3.00 | 3.50 | 2.35 | 2.35 |
| member | Coating layer relative permittivity | 7.5 | 3.0 | 9.7 | 7.5 | 3.0 | 9.7 | 5.0 | 6.0 |
| Antireflection | Thickness (mm) | — | — | — | 1.00 | 0.59 | 1.00 | 1.00 | 1.00 |
| material | Relative permittivity | — | — | — | 2.90 | 2.75 | 3.50 | 3.50 | 3.30 |

| | | | | | | | | |
|---|---|---|---|---|---|---|---|---|
| Average transmission attenuation amount (dB) | −0.55 | −0.83 | −0.51 | −0.16 | −0.04 | −0.45 | −0.06 | −0.09 |

| | |
|---|---|
| Frequency band: | 76.5 ± 2 GHz |
| Dielectric member: | Base layer relative permittivity 2.4 |
| | Coating layer thickness 0.1 mm |

As shown in Tables 2 and 3, the dielectric members with antireflection material of Examples B1 to B3 and Examples C1 to C5 all showed better radio wave transmission than the dielectric members of Examples N1 to N7.

Specifically, the antireflection material of Example B1 may be, for example, an antireflection material B1A having a structure in which the following layers a to d are laminated in this order.

### [Antireflection Material B1A]

Layer a: PSA layer having a thickness of 0.17 mm and a relative permittivity of 2.5 (PSA layer Xa)
Layer b: resin film having a thickness of 0.3 mm and a relative permittivity of 3.1
Layer c: PSA layer having a thickness of 0.17 mm and a relative permittivity of 2.5
Layer d: resin film having a thickness of 0.3 mm and a relative permittivity of 3.1 (resin film Xn)

The antireflection material B1A has a thickness (total thickness) of 0.94 mm and a total relative permittivity calculated by the above formula (A) of 2.88.

Specifically, the antireflection material of Example B2 can be, for example, an antireflection material B2A having a structure in which the following layers a to d are laminated in this order.

### [Antireflection Material B2A]

Layer a: PSA layer having a thickness of 0.17 mm and a relative permittivity of 2.5 (PSA layer Xa)
Layer b: resin film having a thickness of 0.125 mm and a relative permittivity of 3.1
Layer c: PSA layer having a thickness of 0.17 mm and a relative permittivity of 2.5
Layer d: resin film having a thickness of 0.125 mm and a relative permittivity of 3.1 (resin film Xn)

The antireflection material B2A has a total thickness of 0.59 mm and total relative permittivity calculated by the above formula (A) of 2.75.

Specifically, the antireflection material of Example B3 can be, for example, an antireflection material B3A having a structure in which the following layers a to d are laminated in this order.

### [Antireflection Material B3A]

Layer a: PSA layer having a thickness of 0.17 mm and a relative permittivity of 2.5 (PSA layer Xa)
Layer b: resin film having a thickness of 0.33 mm and a relative permittivity of 3.1
Layer c: PSA layer having a thickness of 0.17 mm and a relative permittivity of 2.5
Layer d: resin film having a thickness of 0.33 mm and a relative permittivity of 3.1 (resin film Xn)

The antireflection material B3A has a total thickness of 1.00 mm and total relative permittivity calculated by the above formula (A) of 2.90.

A PSA layer satisfying the above-mentioned relative permittivity and thickness can be selected and used, as appropriate, as the layers a and c constituting Examples B1A to B3A. For example, a PSA layer having a thickness of 0.17 mm that was formed from the PSA composition d1 described hereinbelow can be used. The layers a and c each may be a double-sided PSA layer with a base material, and for example, a double-sided PSA sheet as produced in Example D1a described hereinbelow can be used as such a PSA layer. A resin film (for example, polyethylene terephthalate (PET) film) satisfying the above relative permittivity and thickness can be selected and used, as appropriate, as the layers b and d.

### Test Example 2

### Example N8, Example D1

The average transmission attenuation amount (dB) and the minimum transmission attenuation amount (dB) in the frequency band of 76.5±2 GHz were obtained by the above-described method for a dielectric member (Example N8) and a dielectric member with antireflection material (Example D1) having the configurations shown in Table 4. The obtained results are shown in Table 4 together with the average transmittance (%) corresponding to the average transmission attenuation amount (dB).

### Example D1a

### (Preparation of Antireflection Material)

A total of 100 parts of n-butyl acrylate (BA), 5 parts of vinyl acetate (VAc), 3 parts of acrylic acid (AA), 0.1 part of 2-hydroxyethyl acrylate (HEA), 0.3 part of 2,2′-azobisisobutyronitrile (AIBN) as a polymerization initiator, and toluene as a polymerization solvent were placed in a reaction vessel equipped with a stirrer, a thermometer, a nitrogen gas introduction tube, a reflux cooler, and a dropping funnel, and solution polymerization was carried out at 60° C. for 6 hours to obtain a solution of an acrylic polymer. The weight average molecular weight (Mw) of this acrylic polymer was 55×10⁴.

A total of 40 parts of a tackifying resin and 2 parts of the isocyanate-based crosslinking agent (trade name “Coronate L”, manufactured by TOSOH CORPORATION) with respect to 100 parts of the acrylic polymer contained in the acrylic polymer solution were added to the solution, stirred, and mixed to prepare a PSA composition d1.

The tackifying resin included 10 parts of a polymerized rosin ester (trade name “Haritac PCJ”, manufactured by HARIMA CHEMICALS, INC.) with a softening point of about 125° C., 10 parts of a stabilized rosin ester (trade name “Haritac SE10”, manufactured by HARIMA CHEMICALS, INC.) with a softening point of about 80° C., 5 parts of hydrogenated rosin methyl ester (trade name “M-HDR”, manufactured by WOUZHOU SUN SHINE FORESTRY & CHEMICALS CO., LTD., liquid), and 15 parts of a terpene phenolic resin (trade name “Sumilite Resin PR-12603”, manufactured by SUMITOMO BAKELITE CO., LTD.) with a softening point of about 133° C.

Two polyester release films were prepared, one side of which was a release surface made of a silicone-based release treatment agent. The PSA composition dl was applied to the release surface of these release films and dried to form a PSA layer. The PSA layer was bonded to the first and second surfaces of a 12 μm-thick polyethylene terephthalate (PET) film to prepare a double-sided PSA sheet S1 having a total thickness of 150 μm. The relative permittivity of the double-sided PSA sheet S1 measured at a frequency of 76.5 GHz was 2.5.

The relative permittivity of the double-sided adhesive sheet S1 was measured in an environment of 23° C. and 50% RH by using a permittivity/dielectric loss tangent measurement system Model No. DPS10 (antenna DPS10-01) manufactured by KEYCOM CORP. and analysis software. The same applies to the relative permittivity of the double-sided adhesive sheet S2, the polypropylene resin plate, and the coating layer, which will be described hereinbelow.

Two PET films having a thickness of 0.188 mm (manufactured by TORAY INDUSTRIES, INC., Lumirror S10) and two double-sided adhesive sheets S1 were prepared and alternately laminated to prepare an antireflection material D1a having the configuration shown in FIG. 3. The antireflection material D1a had a total thickness of 0.68 mm and a relative permittivity of 2.82 at a frequency of 76.5 GHz.

(Preparation of Dielectric Member with Antireflection Material)

By attaching the antireflection material D1a obtained above to a dielectric member, a dielectric member with the antireflection material was produced. A dielectric member M1 in which a paint layer (relative permittivity 3.0) having a thickness of 0.1 mm and composed of a polyester-based clear coat material was provided on the first surface of a polypropylene resin plate having a thickness of 2.9 mm and a relative permittivity of 2.5 was used as the dielectric member. The antireflection material D1a was attached to the second surface (non-painted surface) of the dielectric member M1.

(Performance Evaluation)

For the dielectric member with the antireflection material to which the antireflection material of Example D1a was attached, the average transmission attenuation amount (dB) in the frequency band of 76.5 GHz±2 GHz was measured under a measurement environment of 25° C. and 50% RH by using commercially available transmission attenuation amount measurement system (Millimeter-wave/microwave transmission attenuation amount measurement system, Model No. RTS01, manufactured by KEYCOM CORP.) with reference to the method described in JIS R 1679 (Measurement methods for reflectivity of electromagnetic wave absorber in millimeter wave frequency), and the minimum transmission attenuation amount (dB) in the same band was determined.

Further, for the dielectric member E1 (Example N8a) having no antireflection material, the average transmission attenuation amount (dB) and the minimum transmission attenuation amount (dB) were measured in the same manner. The obtained results are shown in Table 4 together with the average transmittance (%) corresponding to the average transmission attenuation amount (dB).

TABLE 4

| | | Example N8 | Example N8a | Example D1 | Example D1a |
|---|---|---|---|---|---|
| | | (calculated) | (measured) | (calculated) | (measured) |
| Dielectric | Base layer thickness (mm) | 2.90 | 2.90 | 2.90 | 2.90 |
| member | Base layer relative permittivity | 2.50 | 2.50 | 2.50 | 2.50 |
| | Coating layer relative permittivity | 3.0 | 3.0 | 3.0 | 3.0 |
| Antireflection | Thickness (mm) | — | — | 0.68 | 0.68 |
| material | Relative permittivity | — | — | 2.82 | 2.82 |

| | | | | |
|---|---|---|---|---|
| Average transmission attenuation amount (dB) | −0.88 | −0.83 | −0.07 | −0.17 |
| Minimum transmission attenuation amount (dB) | −0.91 | −0.93 | −0.20 | −0.29 |
| Average transmittance (%) | 82.0 | 83.0 | 98.4 | 96.2 |

Frequency band: 76.5 ± 2 GHz
Dielectric member: Coating layer thickness 0.1 mm

As shown in Table 4, the dielectric member with the antireflection material of Example D1 demonstrated better radio wave transmission than the dielectric member of Example N8, which was also confirmed by the measured values (comparison of Example N8a and Example D1a).

The relative permittivity described in the present description means the relative permittivity ε′ᵣ, which is a real term of the complex relative permittivity εᵣ=ε′ᵣ−jε″ᵣ. When discussing the transmission and reflection of radio waves passing through a dielectric, for example, in the case of Schelkunoff formula, it is generally necessary to consider the effects of reflection loss, attenuation loss, and multiple reflection effects. In the present description, the attention is focused on the relative permittivity ε′ᵣ, which is an influential factor of reflection loss, but it is conceivable that a dielectric loss ratio ε″ᵣ, which is an influential factor of attenuation loss, also needs to be considered. However, the dielectric loss ratio ε″ᵣ, as the name thereof implies, represents contribution to the loss, and the smaller the absolute value thereof, the lower the loss and smaller the degree to which the radio wave transmission is impaired. Therefore, from the viewpoint of maintaining the radio wave transmission at a high value, it can be said that a smaller dielectric loss ratio ε″ᵣ is desirable.

Further, regarding the transmission attenuation amount that can be calculated using the equations (1) to (4) described in the [Calculation Method of Average Transmission Attenuation Amount] hereinabove, an average transmission attenuation amount that is more consistent with the measured value can be calculated by substituting the physical property value of the complex relative permittivity εᵣ=ε′ᵣ−jε″ᵣ including also the attenuation term ε″ᵣ, rather than the relative permittivity ε′ᵣ of the real number term. A method for measuring the complex relative permittivity is not particularly limited, but the relative permittivity ε′ᵣ of the real number term may be measured by the same method as described above, and the dielectric loss ratio ε″ᵣ may be measured as the dielectric constant tangent by using the same measurement as that of the relative permittivity, for example, by an open resonator method, a free space frequency change method, an S parameter method, or the like.

In Test Example 3 below, the transmission attenuation amounts of the dielectric member and the dielectric member with the antireflection material are calculated using the measured values of the complex relative permittivity of each material, and these calculation results are compared with the measured values for the corresponding dielectric member and the dielectric member with the antireflection material.

### Test Example 3

### Example N9, Example E1

For the dielectric member (Example N9) and the dielectric member with antireflection material (Example El) having the configurations shown in Table 5, the transmission attenuation amounts of the dielectric member and the dielectric member with antireflection material were calculated using the measured values of the complex relative permittivity of each material. The obtained results are shown in Table 5 together with the average transmittance (%) corresponding to the average transmission attenuation amount (dB).

### Example E1a

### (Preparation of Antireflection Material)

A double-sided PSA sheet S2 having a total thickness of 170 μm was prepared by directly applying the PSA composition dl to each side of a non-woven fabric (thickness 75 μm, density 0.31 g/cm3) in which 99% by weight of Manila hemp was mixed with 1% by weight of vinylon, so that each side had the same weight, and drying to form a PSA layer. The relative permittivity of the double-sided PSA sheet S2 measured at a frequency of 76.5 GHz was 2.5.

Two PET films having a thickness of 0.188 mm (manufactured by TORAY INDUSTRIES, INC., Lumirror S10) and two double-sided adhesive sheets S2 were prepared and alternately laminated to prepare an antireflection material E1a having the configuration shown in FIG. 3. The antireflection material E1a had a total thickness of 0.72 mm and a relative permittivity of 2.83 at a frequency of 76.5 GHz.

(Preparation of Dielectric Member with Antireflection Material)

The obtained antireflection material E1a was attached to a dielectric member to prepare a dielectric member with antireflection material. A dielectric member M2 in which a paint layer (relative permittivity 7.5) formed with a polyester-based clear coat material and a silver-based coating film was provided on the first surface of a polypropylene resin plate having a thickness of 2.70 mm and a relative permittivity of 2.4 was used as the dielectric member. The antireflection material E1a was attached to the second surface (non-painted surface) of the dielectric member M2.

(Performance Evaluation)

For the dielectric member with antireflection material to which the antireflection material of Example E1a was attached and the dielectric member M2 (Example N9a) having no antireflection material, the average transmission attenuation amount (dB) and the minimum transmission attenuation amount (dB) were measured in the same manner as described above. The obtained results are shown in Table 5 together with the average transmission attenuation amount (dB) and average transmittance (%).

TABLE 5

| | | Example N9 | Example N9a | Example E1 | Example E1a |
|---|---|---|---|---|---|
| | | (calculated) | (measured) | (calculated) | (measured) |
| Dielectric | Base layer thickness (mm) | 2.7 | 2.7 | 2.7 | 2.7 |
| member | Base layer relative permittivity ∈′ᵣ | 2.4 | 2.4 | 2.4 | 2.4 |
| | Base layer complex dielectric loss ∈″ᵣ | 0 | — | 0 | — |
| | Coating layer relative permittivity ∈′ᵣ | 7.5 | 7.5 | 7.5 | 7.5 |
| | Coating layer complex dielectric loss ∈″ᵣ | 0.2 | — | 0.2 | — |
| Antireflection | Thickness (mm) | — | — | 0.72 | 0.72 |
| material | Relative permittivity ∈′ᵣ | — | — | 2.83 | 2.83 |
| | Dielectric loss ∈″ᵣ | — | — | 0.05 | — |

| | | | | |
|---|---|---|---|---|
| Average transmission attenuation amount (dB) | −1.55 | −1.48 | −0.39 | −0.45 |
| Minimum transmission attenuation amount (dB) | −1.7 | −1.71 | −0.47 | −0.52 |
| Average transmittance (%) | 70 | 71 | 91.4 | 90 |

Frequency band: 76.5 ± 2 GHz
Dielectric member: Coating layer thickness 0.1 mm

As shown in Table 5, the dielectric member with antireflection material of Example E1 showed better radio wave transmission than the dielectric member of Example N9, which was also confirmed by the actually measured value (comparison between Example N9a and Example E1a). Further, from the comparison between Tables 4 and 5, it can be seen that where the transmission attenuation amount is calculated using the complex relative permittivity, better correlation with the measured value can be obtained, in particular, for the dielectric member with antireflection material.

Although specific examples of the present invention have been described in detail above, these are merely examples and do not limit the scope of claims. The techniques described in the claims include various changes and modifications of the specific examples illustrated above.

### REFERENCE SIGNS LIST

1, 2 Antireflection materials
10 PSA layer (surface layer Xa)
10A First surface (adhesive surface)
10B Second surface
12 PSA layer (intermediate layer)
22 Resin film (back layer Xn)
24 Resin film (intermediate layer)
30 Release liner
40 Bumper (dielectric member)
40A Outer surface
40B Inner surface
42 Resin molded body (base layer)
42A Outer surface
44 Paint layer (coating layer)
50 Bumper with antireflection material (dielectric member with antireflection material)
80 Radar device
90 Vehicle body
100 In-vehicle radar system

1. An antireflection material used by being laminated on a dielectric member that reflects a radio wave, to reduce reflection of the radio wave, wherein
the dielectric member includes a base layer and a coating layer laminated on the base layer,
the base layer has a thickness T_{YB} of 1.2 mm or more and 3.5 mm or less, and the coating layer has a relative permittivity ε_{YC} of 3.0 or higher,
the antireflection material has a thickness T_{X} of 10 mm or less, and
the antireflection material has a relative permittivity ε_{X} of 2.0 or more and 7.0 or less.

2. The antireflection material according to claim 1, wherein the antireflection material has the relative permittivity ε_{X} of 2.0 or more and 4.5 or less.

3. The antireflection material according to claim 1, wherein the antireflection material has the thickness T_{X} of 0.05 mm or more and 2.00 mm or less.

4. The antireflection material according to claim 1, wherein the antireflection material includes a pressure-sensitive adhesive layer Xa constituting a first surface of the antireflection material and is configured to be capable of being fixed to the dielectric member by the pressure-sensitive adhesive layer Xa.

5. The antireflection material according to claim 4, wherein the antireflection material includes a resin film Xn, which is a layer constituting a second surface of the antireflection material.

6. A bumper with an antireflection material, comprising the antireflection material according to claim 1 and a vehicle bumper as the dielectric member.

7. The bumper with an antireflection material according to claim 6, wherein the coating layer is arranged on an outer surface of the base layer, and the antireflection material is laminated on an inner surface of the base layer.

8. An in-vehicle radar system comprising:
the antireflection material according to claim 1;
the dielectric member on which the antireflection material is laminated; and
a radar device that transmits and receives a radio wave, wherein
the antireflection material and the dielectric member are arranged in a transmission/reception path of the radio wave.
